(19) United States
(12) Patent Application Publication
(10) Pub. No.: US 2022/0182387 A1
(43) Pub. Date: Jun. 9, 2022

(54) SYSTEM, METHOD, AND COMPUTER PROGRAM FOR CONTROLLING ACCESS TO A CAMERA FEED

(71) Applicant: Kevin J. Zilka, Los Gatos, CA (US)

(72) Inventor: Kevin J. Zilka, Los Gatos, CA (US)

(21) Appl. No.: 17/369,813

(22) Filed: Jul. 7, 2021

Related U.S. Application Data
(60) Provisional application No. 63/121,676, filed on Dec. 4, 2020.

(51) Int. Cl. H04L 29/06; H04L 29/08

(52) U.S. Cl. CPC H04L 63/101; H04L 67/12; H04L 67/306; H04L 63/107

(57) ABSTRACT

A system, method, and computer program are provided for: receiving first appointment information selected by a first user, the first appointment information corresponding with a first time window. In addition, second appointment information selected by a second user is received, the second appointment information corresponding with a second time window. Additionally, a first option is sent to the first user via a network for, in response to a selection thereof by the first user, permitting access to a camera feed of a camera during the first time window by only the first user. Further, a second option is sent to the second user via the network for, in response to a selection thereof by the second user, permitting access to the camera feed of the camera during the second time window by only the second user.

### CROSS-REFERENCE TO RELATED APPLICATIONS

This application claims the benefit of U.S. Provisional Application No. 63/121,676 (Attorney Docket No. MARC1P003+) titled “SYSTEM, METHOD, AND COMPUTER PROGRAM FOR CONTROLLING ACCESS TO A CAMERA FEED,” filed Dec. 4, 2020, the entire contents of which is incorporated herein by reference.

### FIELD OF THE INVENTION

The present invention relates to camera feeds and, more particularly, controlling access to camera feeds.

### BACKGROUND

There are a variety of situations where access to a camera feed (of a camera) is desired by a first person during a first time period and is desired by a second person during a second time period. In such situations, it can be difficult to control access to the camera feed (of the camera) by the appropriate person at the appropriate time.

As such, there is thus a need for addressing these and/or other issues associated with the prior art.

### SUMMARY

A system, method, and computer program are provided for: receiving first appointment information selected by a first user, the first appointment information corresponding with a first time window. In addition, second appointment information selected by a second user is received, the second appointment information corresponding with a second time window. Additionally, a first option is sent to the first user via a network for, in response to a selection thereof by the first user, permitting access to a camera feed of a camera during the first time window by only the first user. Further, a second option is sent to the second user via the network for, in response to a selection thereof by the second user, permitting access to the camera feed of the camera during the second time window by only the second user.

### BRIEF DESCRIPTION OF THE DRAWINGS

FIG. 1 illustrates a method for scheduling appointments for multiple users.

FIG. 2 illustrates a flow chart for permitting video access to only a single designated user during an allocated time period.

FIG. 3 illustrates an exemplary mobile pet grooming facility with a camera accessible to users via a network.

FIG. 4 illustrates a user interface through which a user may schedule a video access session.

FIG. 5 illustrates a timeline with subsequent designated video access periods allocated to successive users.

FIG. 6 illustrates a network architecture, in accordance with one possible embodiment.

FIG. 7 illustrates an exemplary system, in accordance with one embodiment.

### DETAILED DESCRIPTION

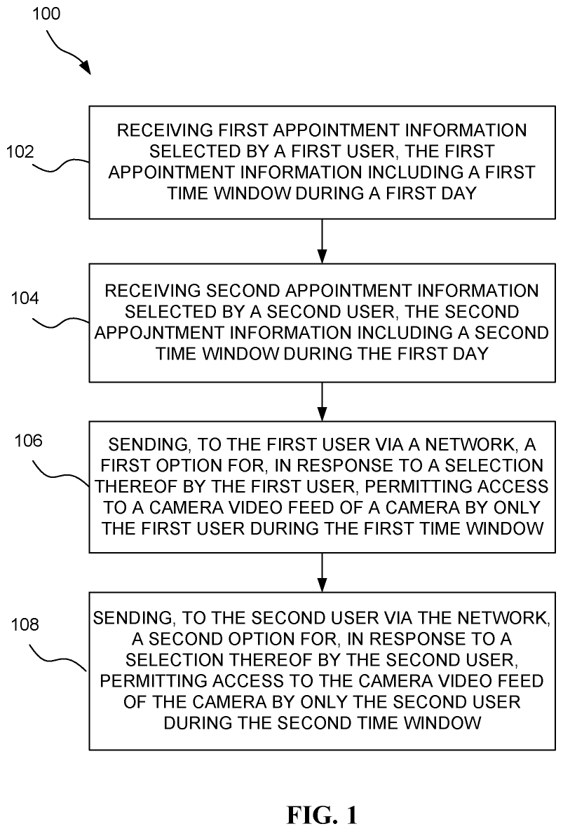

FIG. 1 illustrates a method 100 for scheduling appointments for multiple users.

As shown, first appointment information selected by a first user is received, the first appointment information corresponding with a first window. See operation 102. In the context of the present description, the first appointment information may include or may reference (e.g. link to, be able to otherwise generate, etc.) information that includes (like shown in FIG. 1) or is at least capable of being used to identify or otherwise generate at least one parameter (e.g. start and/or end date or time of day, duration, location, etc.) that is, in turn, capable of being used to identify the first window. Also in the context of the present description, the first window includes any window (subset) of time. It should be noted that any portion of the first window (e.g. duration, start or end time, location etc.) may be assumed, so that such assumed portion need not necessary (but may) be defined or definable by the first appointment information. For example, the first appointment information may simply indicate that the first window is to beginning immediately, where the first window lasts a predetermined/fixed time frame (e.g. duration) thereafter or the first window lasts until a subsequent stop instruction is received from the first user (e.g. from the same interface by which the first appointment information is selected).

Further, the first appointment information may be received in any desired manner. For example, the first appointment information may be received via a graphical user interface or portions thereof that are interacted with (selected) by a user (an example of which will be described later), and/or may be received via at least network (an example of which will be described later).

In addition, second appointment information selected by a second user is received, the second appointment information corresponding with a second time window. See operation 104. In the context of the present description, the second appointment information may include or may reference (e.g. link to, be able to otherwise generate, etc.) information that includes (like shown in FIG. 1) or is at least capable of being used to identify or otherwise generate at least one parameter (e.g. start and/or end date or time of day, duration, location, etc.) that is, in turn, capable of being used to identify the second window. Also in the context of the present description, the second window includes any window (subset) of time that differs from the first window. In one embodiment, the first and second windows may be mutually exclusive with no overlap. In another embodiment, the first and second windows may overlap at least in part.

Similar to the first appointment information, it should be noted that any portion of the second window (e.g. duration, start or end time, location etc.) may be assumed, so that such assumed portion need not necessary (but may) be defined or definable by the second appointment information. For example, the second appointment information may simply indicate that the first window is to beginning immediately, where the second window lasts a predetermined/fixed time frame (e.g. duration) thereafter or the second window lasts until a subsequent stop instruction is received from the second user (e.g. from the same interface by which the second appointment information is selected). Further, the second appointment information may be received in any desired manner. For example, the second appointment information may be received via a graphical user interface or portions thereof that are interacted with (selected) by a user (an example of which will be described later), and/or may be received via at least network (an example of which will be described later).

With continuing reference to FIG. 1, a first option is sent to the first user via a network for, in response to a selection thereof by the first user, permitting access to a camera feed of a camera by only the first user during the first time window. See operation 106. In the context of the present description, the camera may include a single camera with a single perspective of a target area, or multiple cameras with different perspectives of the target area. Further, the camera feed includes at least one frame from the camera. Thus, the camera feed may include a video or portion thereof, a still picture, etc.

Also in the context of the present description, the first option may include a graphical user interface element, related indicia, a link (e.g. a hyperlink, portion of hypertext, etc.), an option icon or button, a combination of any of the foregoing, etc. Further, the first option may or may not be displayed in a same interface and/or using the same application that was used by the first user to select the first appointment information.

Even still, in one embodiment, “the camera feed of the camera . . . during the first time window” refers to the camera feed that was collected and/or received during at least a portion of the first time window. Further, the aforementioned access may be provided in any manner that permits the first user to view the camera feed. For example, in one embodiment, the aforementioned access may be provided to permit the first user to view the camera feed only in-real time (when/while the camera feed is being collected and/or received and/or during at least the portion of the first time window). In one embodiment, the aforementioned access may be provided to permit the first user to view the camera feed only after the first time window is completed (and/or the camera feed is no longer being collected/received). In such embodiment, the camera feed may be stored until it is accessed or after a predetermined expiration timeframe that follows the camera feed collection. In still another embodiment, a combination of the above options may be provided to the first user.

Still yet, in the context of the present description, permitting access to the camera feed of the camera by only the first user during the first time window may include any restriction that prevents other users (e.g. the second user, etc.) from accessing the camera feed during the first time window. For example, an administrator, governmental agency, system owner, etc. may still access the camera feed during the first time window, while still permitting access to the camera feed of the camera by only the first user during the first time window.

Further, a second option is sent to the second user via the network for, in response to a selection thereof by the second user, permitting access to the camera feed of the camera by only the second user during the second time window. See operation 108. In the context of the present description, the second option may include a graphical user interface element, related indicia, a link (e.g. a hyperlink, portion of hypertext, etc.), an option icon or button, a combination of any of the foregoing, etc. Further, the second option may or may not be displayed in a same interface and/or using the same application that was used by the second user to select the second appointment information.

Even still, in one embodiment, “the camera feed of the camera . . . during the second time window” refers to the camera feed that was collected and/or received during at least a portion of the second time window. Further, the aforementioned access may be provided in any manner that permits the second user to view the camera feed. For example, in one embodiment, the aforementioned access may be provided to permit the second user to view the camera feed only in-real time (when/while the camera feed is being collected and/or received and/or during at least the portion of the second time window). In one embodiment, the aforementioned access may be provided to permit the second user to view the camera feed only after the second time window is completed (and/or the camera feed is no longer being collected/received). In such embodiment, the camera feed may be stored until it is accessed or after a predetermined expiration timeframe that follows the camera feed collection. In still another embodiment, a combination of the above options may be provided to the second user.

Still yet, in the context of the present description, permitting access to the camera feed of the camera by only the second user during the second time window may include any restriction that prevents other users (e.g. the first user, etc.) from accessing the camera feed during the second time window. For example, an administrator, governmental agency, system owner, etc. may still access the camera feed during the second time window, while still permitting access to the camera feed of the camera by only the second user during the second time window.

In one embodiment, the first option and the second option may be identical, but may provide different results (i.e. provide access to different users) based on various parameters, etc. (e.g. location, time, access code/password, etc.). In another embodiment, the first option and the second option may different in at least one aspect (e.g. have different links, etc.).

More illustrative information will now be set forth regarding various optional architectures and uses in which the foregoing method may or may not be implemented, per the desires of the user. Any of the following features may be optionally incorporated with or without the other features described.

For example, in one embodiment, the first appointment information may be provided for the purpose of the first user scheduling a camera feed access in order to remotely view and/or monitor a pet grooming session within a mobile pet grooming facility, wherein the first appointment information includes a first location of the first user such that a selectable link is accessible only by the first user based on the camera being within a predetermined distance from the first location. In such embodiment, the second appointment information may be provided for the purpose of the second user scheduling a different camera feed access in order to remotely view and/or monitor a second pet grooming session within the same mobile pet grooming facility, wherein the second appointment information includes a second location of the second user such that a selectable link is accessible only by the second user based on the camera being within a predetermined distance from the second location and such that no two video access sessions overlap completely (or even partially, in some embodiments).

As yet another example of an optional feature, the first and/or second appointment information may include preference information that indicates any desired preferences for the camera feed (e.g. color, B/W, camera selection, automatic panning, etc.). Such preferences may also be stored for use during subsequently-scheduled appointments. In other embodiments, any of the above preferences may also be received any time after the first and/or second appointment information is received (i.e. during the first and/or second window).

As still yet another example of an optional feature, prior to providing full access to the camera feed for the scheduled time duration, a preview of the camera feed may be provided. This preview may be accessed via an option separate from the aforementioned options and/or be provided in response to selection of any of the aforementioned options at a time that precedes the relevant first and/or second time window. To protect privacy of other users, such preview may simply include a still “stock” frame view of the camera feed(s) that is provided by an administrator and/or owner of the facility in which the camera(s) are installed.

Further, in one embodiment, the first option may include a selectable link that is different from a selectable link sent to a second user and accessible only by the first user during the first time window, wherein the first option for permitting access to the camera feed may appear to the first user in the form of an electronic communication. For example, the first user may learn of the first option in the form of an electronic mail message, an SMS-based text message, and/or a digital recording of a voice message containing the details of the first option. In another embodiment, the first option for permitting access to the camera feed may be accessible using a hyperlink or URL sent to the first user as a result of receiving the first appointment information from the user as in operation 102. Also, the second option may include a selectable link that is different from the selectable link sent to the first user and accessible only by the second user during the second time window, wherein the second option for permitting access to the camera feed may appear to the second user in the form of an electronic communication. For example, the second user may learn of the second option in the form of an electronic mail message, an SMS-based text message, and/or a digital recording of a voice message containing the details of the second option. In another embodiment, the second option for permitting access to the camera feed may be accessible using a hyperlink or URL sent to the second user as a result of receiving the second appointment information from the second user as in operation 104.

It should be noted that, in other embodiments, the system, method, and computer program described herein may be employed in additional mobile and fixed-station applications to, by way of non-exhaustive example, provide for real and personal property monitoring, individual instruction sessions, hotel room monitoring, rental automobile monitoring, real-time remote workplace interactions, and point-of-view camera transmissions associated with various motorized and non-motorized vehicles (e.g. boats, cars, bicycles, scooters, skateboards, ski equipment, etc.). Thus, the present embodiments should not be deemed limited to mobile vehicles, let alone limited to mobile pet grooming vans.

To this end, any application where multiple users desire exclusive access to a camera at predetermined times and/or locations (of the camera and/or scheduling user), may benefit from any one or more features disclosed herein. Further, at the time of scheduling, the user need not even know that access to the camera feed is going to be available. For example, the user may simply be scheduling a location (e.g. building or portion thereof) or vehicle, and the camera access simply coincides with such scheduling. In yet another embodiment, the scheduling a location (e.g. building or portion thereof) or vehicle may be equipped with an option that may be selected (via a graphical user interface element) to enable the camera to collected the camera feed and/or permit access the camera feed.

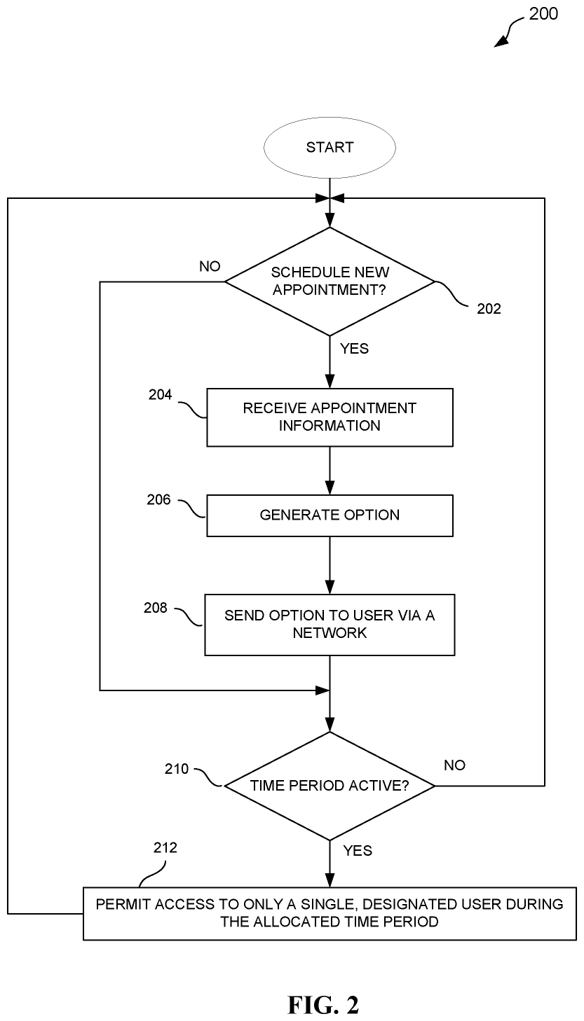

FIG. 2 illustrates a flow chart 200 for permitting video access to only a single designated user during an allocated time period, in accordance with one embodiment. As an option, the flow chart 200 may be implemented in the context of any one or more of the embodiments set forth in any previous and/or subsequent figure(s) and/or description thereof. Of course, however, the flow chart 200 may be implemented in the context of any desired environment. Further, the aforementioned definitions may equally apply to the description below.

In operation, it is determined whether a user desires to make a new appointment and schedule a video access session. See decision point 202. If it is determined that the user does not want to make a new appointment to access video transmission (and assuming that at least one appointment currently exists), the system moves forward to decision point 210 to determine whether the current time period is active, such that a user has an appointment scheduled for the current time period. In such case, the user is allowed exclusive access to the video transmission as in operation 212.

On the other hand, if it is determined that a user wants to schedule a new appointment to access video transmission, the user may be presented a user interface (an example of which will be described later) through which the user may schedule a video access appointment and transmit that information to the scheduling system, per operation 204.

In addition, the system, based upon the user's information provided in operation 204, the system may generate an option for scheduling an appointment to access the video transmission in operation 206 and send that option to the user via a network. See operation 208. In one embodiment, a first access code is sent only to the first user, and a second access code is sent only to the second user, such that the same selectable link is accessible only by the first user during the first time window based on receipt of the first access code, and the same selectable link is accessible only by the second user during the second time window based on receipt of the second access code. For example, the user may learn of the scheduling option in the form of an electronic mail message, an SMS-based text message, and/or a digital recording of a voice message containing the details of the scheduling option. In another embodiment, the option for permitting access to the camera feed may be accessible using a hyperlink or URL sent to the user as a result of receiving the appointment information from the user (e.g. as in operation 102 and/or 104 of FIG. 1, for example).

In another embodiment, a first option may be sent to the first user and a second option may be sent to a second user such that the first/second options include different selectable links including a first selectable link that is only sent to the first user, and a second selectable link that is only sent to the second user. As an option, the options may include a first selectable link that is only sent to the first user and that is accessible only during the first time window, and a second selectable link that is only sent to the second user and that is accessible only during the second time window. As yet another option, the respective links may be accessible at any time during and/or after the corresponding time window.

Further, a scheduling system may determine whether the specified appointment time period is active for the current user, as set forth earlier during reference to decision point 210. If it is determined that the proposed time period is not active, the system may return the user to the beginning of the process whereby it may be determined whether a user desires to schedule a new appointment as in decision point 202.

Further still, if it is determined that the time period for the appointment from decision point 210 is active for the current user, the user may be granted exclusive access to the camera feed system for the duration of the allocated time period (see operation 212) and the system thereafter returns to the beginning of the process whereby it may be determined whether a user desires to schedule a new appointment as in decision point 202.

In one embodiment, such exclusive access may result in a single camera feed of a single camera being accessible to the user. In another embodiment, such exclusive access may result in a plurality of camera feeds of multiple cameras being accessible to the user. In the latter embodiment, the camera feeds may be displayed simultaneously. As another option, camera feeds may be displayed one (or other subset of more) at a time, where such camera feeds are automatically selected based on which camera feed includes motion. As yet another option, camera feeds may be displayed one (or other subset of more) at a time, where such camera feeds are manually selected based on user input that is received remotely, or manual input received at the location of the camera.

As yet another option, the camera(s) may be equipped with a speaker and/or a display for allowing the user (associated with the active time period) to cause visual feedback (e.g. another camera feed displaying the user) and/or audible feedback (e.g. voice of the user) in the area in which the camera feed(s) is being collected.

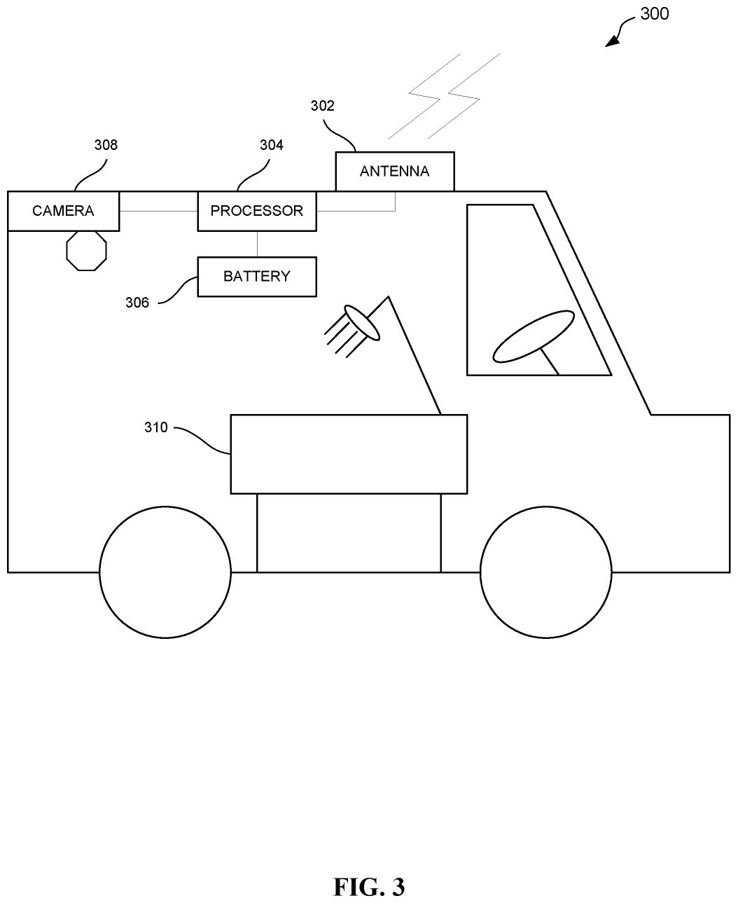

FIG. 3 illustrates an exemplary mobile pet grooming facility 300 with a camera accessible to users via a network.

As shown, a mobile pet grooming facility 300 may include components necessary to provide exclusive remote video access to authorized individual users. In one embodiment, the mobile pet grooming facility may include an antenna 302 for connecting to a network. In addition, the antenna 302 may be connected to a processor component 304 that may operate to activate the camera 308 within the mobile pet grooming facility.

While the camera 308 is disclosed within the facility, it should be noted that, in this and other embodiments involving buildings, rooms thereof, etc., multiple cameras may be utilized inside and/or outside of the facility. Further, the cameras may be fixedly attached to the facility, and/or have the ability to mechanical move (or have a viewport electronically moved) to improve view of the target area. Any mechanical and/or electrical movement may be under the control of either the user (remotely) or a person inside the facility.

Additionally, the antenna, processor, and camera system may be connected to a battery 306 suitable to enable the antenna, processor, and camera to provide a camera feed to a remote user. In another embodiment, the mobile pet grooming facility may include a pet bathing vessel 310 visible to the camera 308 to provide video access to the user during a scheduled pet grooming meeting.

In one embodiment, the antenna 302 may be a satellite antenna and/or satellite hotspot capable of providing remote video access to one or more users in succession. In another embodiment, the antenna 302 may be part of and/or connected to a global positioning satellite component. In yet another embodiment, the antenna 302 may be part of and/or connected to a component capable of covering cellular bands. In still another embodiment, the antenna 302 may be part of and/or connected to a portable WiFi router designed to operate in a mobile facility.

In one embodiment, the processor component 304 may include a transceiver with local area network (LAN) and/or wide area network (WAN) connectors designed to transmit and receive packetized data communications.

In one embodiment, the battery component 306 may include a battery system that may be rechargeable via solar energy recharging and/or plug-in recharging. For example, the battery component 306 may be constructed, at least in part, of lithium-ion, lithium iron phosphate, lithium polymer, nickel-cadmium, nickel-metal hydride, zinc-air, sodium nickel chloride, lead-acid, and/or ultracapacitor materials.

In one embodiment, the camera component 308 may include a security camera, an internet protocol (IP) camera, and/or a closed-circuit television (CCTV) camera.

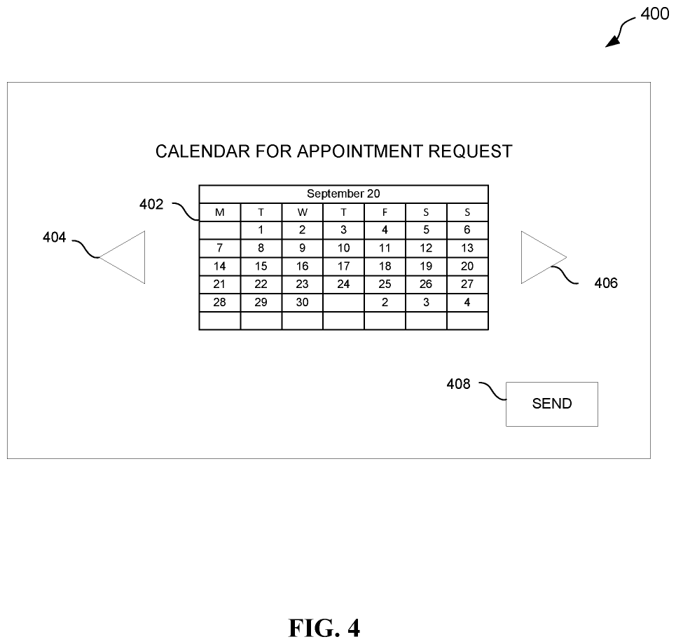

FIG. 4 illustrates a user interface 400 through which a user may schedule a video access session.

As an option, the scheduling tool user interface may include a visual calendar 402 designed to allow selection of a potential day (and/or time/timeframe during such day) on which to schedule video access. In addition, the user interface may include an advance button 406 and a back button 404 designed to move between subsequent and previous calendar months. Further, the user interface may include a “Send” button 410 designed to indicate to the scheduling system that the user would like to schedule an available video access time slot on a particular day/time.

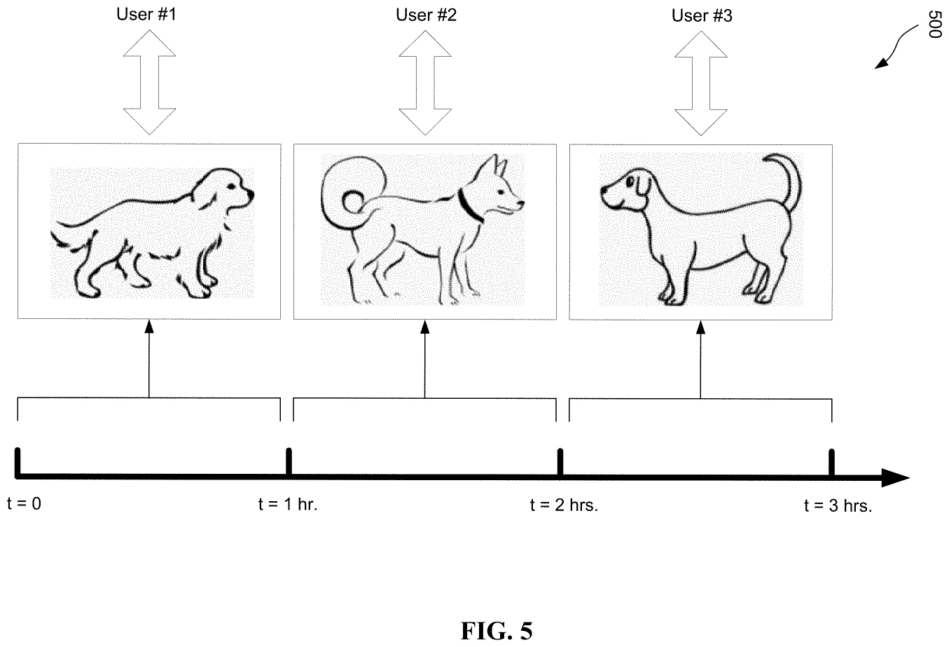

FIG. 5 illustrates a timeline 500 with subsequent designated video access periods allocated to successive users.

As shown, subsequent users (“User #1,” “User #2,” and “User #3” in this non-limiting example) may be allocated periods of time within which the users may access a camera feed from within a mobile pet grooming facility, exclusively. By design, each user may access the camera feed for the time period coinciding with that user's scheduled pet grooming session within the mobile grooming facility. It should be noted that the exemplary time periods in this illustration are not intended to be limiting in any form. For instance, in one embodiment, subsequent user video access time periods may grow or shrink to longer or shorter times as appropriate. For example, subsequent sessions may last 15 minutes and/or may exceed the one hour example provided in this illustration.

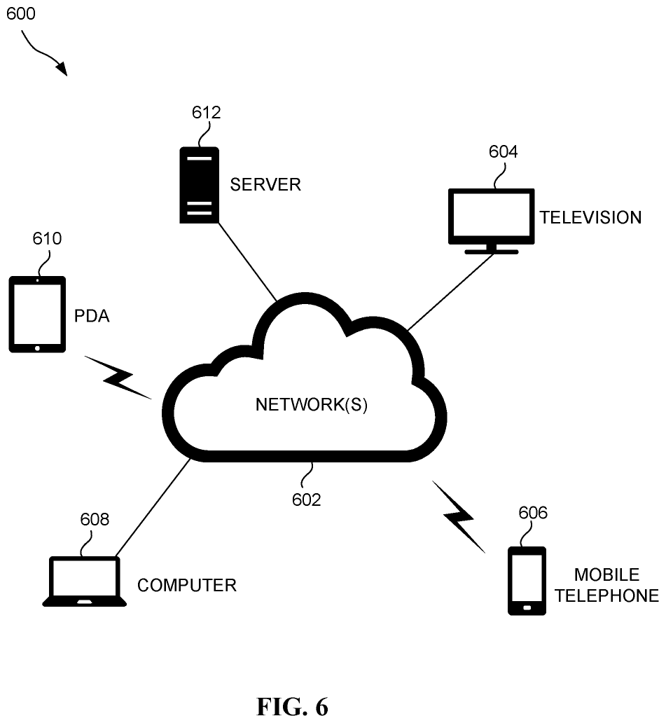

FIG. 6 illustrates a network architecture 600, in accordance with one possible embodiment. As shown, at least one network 602 is provided. In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

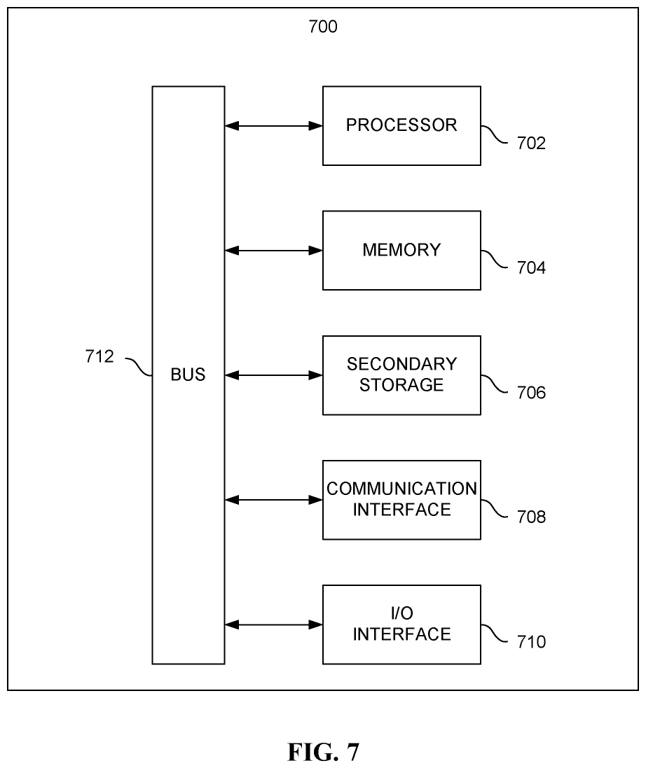

FIG. 7 illustrates an exemplary system 700, in accordance with one embodiment. As an option, the system 700 may be implemented in the context of any of the devices of the network architecture 600 of FIG. 6. Of course, the system 700 may be implemented in any desired environment.

As shown, a system 700 is provided including at least one central processor 702 which is connected to a communication bus 712. The system 700 also includes main memory 704 [e.g., random access memory (RAM), etc.]. The system 700 also includes a graphics processor 708 and a display 710.

The system 700 may also include a secondary storage 706. The secondary storage 706 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 706, and/or any other memory, for that matter. Such computer programs, when executed, enable the system 700 to perform various functions (as set forth above, for example). Memory 704, storage 706 and/or any other storage are possible examples of non-transitory computer-readable media. It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method, comprising:
at a system:
receiving first appointment information selected by a first user, the first appointment information corresponding with a first time window;
receiving second appointment information selected by a second user, the second appointment information corresponding with a second time window;
sending, to the first user via a network, a first option for, in response to a selection thereof by the first user, permitting access to a camera feed of a camera during the first time window by only the first user; and
sending, to the second user via the network, a second option for, in response to a selection thereof by the second user, permitting access to the camera feed of the camera during the second time window by only the second user.

2. The method of claim 1, wherein the first option sent to the first user and the second option sent to the second user include a same selectable link that is accessible only by the first user during the first time window and that is accessible only by the second user during the second time window.

3. The method of claim 2, wherein a first access code is sent only to the first user, and a second access code is sent only to the second user, such that the same selectable link is accessible only by the first user during the first time window based on receipt of the first access code, and the same selectable link is accessible only by the second user during the second time window based on receipt of the second access code.

4. The method of claim 2, wherein the first appointment information includes a first location of the first user, and the second appointment information includes a second location of the second user, such that the same selectable link is accessible only by the first user based on the camera being within a predetermined distance from the first location, and the same selectable link is accessible only by the second user based on the camera being within the predetermined distance from the second location.

5. The method of claim 1, wherein the first option sent to the first user and the second option sent to the second user include different selectable links including a first selectable link that is only sent to the first user, and a second selectable link that is only sent to the second user.
